(19) United States
(12) Patent Application Publication
(10) Pub. No.: US 2012/0234500 A1
(43) Pub. Date: Sep. 20, 2012

(54) TIRE BEAD BREAKER

(76) Inventors: Sandy Ochoa, Alamogordo, NM (US); Justin Ochoa, Alamogordo, NM (US)

(21) Appl. No.: 13/419,039

(22) Filed: Mar. 13, 2012

Related U.S. Application Data
(60) Provisional application No. 61/452,707, filed on Mar. 15, 2011.

(51) Int. Cl. B60C 25/13

(52) U.S. Cl. 157/1.17

(57) ABSTRACT

An apparatus and method for breaking a tire bead from a rim. Interchangeable grappling hook offers three distinct points of contact to more effectively work on a range of tires and rims. A first contact point with a broadened hook is less aggressive for lighter contact on rims thereby reducing marring or scratching. A second contact point comprising a notch grapples rims with large ledges or flanges that do not allow surface clamping. A third point of contact is an aggressive gouge for commercial or agricultural rims. Grappling hook has a landing surface for a linear drive that actuates the hook. The bead breaker includes a right angle leverage point to increase the stability during operation and greater setting force to the grappling hook during a clamping procedure.

### CROSS-REFERENCE TO RELATED APPLICATIONS

This application claims priority to Provisional Application Ser. No. 61/452,707 filed on Mar. 15, 2011, entitled ‘Tire Bead Breaker’.

### BACKGROUND OF THE INVENTION

1. Field of the Invention (Technical Field)

The presently claimed invention relates to tire tools and more specifically to an apparatus and method to break a tire bead of a mounted tire from a rim.

2. Background Art

Bead breaking devices have taken on many forms due to the variety of tire and rim combinations being used. Most early bead breakers were used on tube type tires as the invention of the tubeless tire came much later. These bead breakers ranged in construction from simple leverage devices to screw driven mechanisms to more recently hydraulically or pneumatically driven devices. The principles of bead breaking have always been the same, no matter what form they may have taken in regard to their construction. The principle of forcing the bead away from the rim was a key in the operation of these devices. Some accomplished this with linear force, others with leverage, or centrifugal force, while yet others accomplished this with a combination of all three. With the advent of tubeless tires the construction of rims and tires changed in a way significant enough to warrant new devices for bead breaker construction. These changes presented many challenges in bead breaker design. These challenges presented themselves in the multitude of shapes and forms that the impingement elements of a bead breaker might need to take in order to properly and effectively engage with the tire rim and bead. Another challenge was the need for greater driving forces to effectively displace the new bead forms away and free of the new rim forms. Further challenges were presented in design for more robust and durable drive elements. It further presented challenges in the method of engaging the bead breaking shapes and forms through leverage, centrifugal, or linear force. And finally, challenges in the method of first engaging the rim and secondly striping the bead free of the rim in two distinct stages. While some of these issues are addressed by prior art inventions for breaking the bead, none of them serves to treat all of these challenges in a satisfactory way. Some of the prior art devices have an abundance of power using either pneumatic or hydraulic drive elements but they lack either robust construction or they fail to accomplish this task with two distinctly independent elements, first engaging the rim, and secondly striping the bead. Some of the prior art devices may use centrifugal force, linear forces, or leverage forces but never an effective combination of all three. And finally the prior art devices have forms for engaging the rims and tire beads but not in a way most effective for the placing the driving forces in an efficient manner for engaging the rim and tire bead.

The presently claimed bead breaker does not propose to re-invent the basic principles of bead breaking but rather seeks to significantly improve on the implementation of its well established methods with what is an amalgamation of improved design and function. This is accomplished through a significantly more robust construction having drive elements that use a combination of heavily threaded screw drives that can be propelled by a pneumatically driven impact gun thereby providing a significant improvement in engagement forces. It further seeks to improve on the shapes and forms for engaging the tires and wheels with elements that both provide greater leveraging force and improved angles of impingement along with greater striping forces. It further seeks to improve on the positional force of these drive mechanisms by optimizing where the said force is applied between the tire and rim with the use of a right angle leverage point. It further seeks to improve on the prior art with the use of independent mechanisms for first clamping and positioning the bead breaker between the tire and rim with the use of centrifugal forces used in conjunction with leverage elements and then secondly stripping the bead free of the said rim flange with linear driving force in two distinct stages. Finally the presently claimed invention seeks to effectively engage a variety of rim and tire shapes with a multitude of impingement forms in a single bead breaker that can be used on a wide range of tire beads.

### SUMMARY OF THE INVENTION

### Disclosure of the Invention

The claimed invention is a significant improvement over the prior art bead breakers and overcomes the problems set forth above. The improvements of the claimed invention center around two distinct elements, an improved grappling hook to more effectively engage the rim, an improved leveraging point to better facilitate rim engagement, and increased separation between the wheel and tire bead. These improved elements work in conjunction with an air impact or manually driven bead breaker. There are a number of bead breakers on the market but have completely or adequately addressed the unique stresses placed on the working elements of an air impact bead breaker nor have they addressed the issues of versatility in order to work on a wide range of tire shapes and rims. The presently claimed invention effectively addresses these issues in a number of ways.

In one embodiment an improved interchangeable grappling hook offers three distinct points of contact to more effectively work on an ever increasing range of tires and rims. This single hook is easily interchangeable from one point of contact to another by simply pulling the pivot pin, turning the hook one hundred and eighty 180 degrees, and re-inserting the pivot pin. One side of the improved grappling hook is a contact point that is less aggressive for lighter contact on chrome or alloy rims thereby reducing marring or scratching of the rim. It accomplishes this with a broadened hook design. A second side of the grappling hook has a point of contact that grapples rims with large ledges or flanges that do not allow surface clamping. It accomplishes this with the use of a notch design in the grappling hook. Finally, the second side of the grappling hook has a third point of contact that is a more aggressive single point gouge. This gouge serves to grapple larger commercial or agricultural rims where consideration for cosmetics is not an issue but the additional gripping force is required. It accomplishes this with the use of a hardened set screw or bolt with a cupped edge or a point that grabs and sets firmly into the rim face. Due to the versatility of the bead breaker, the claimed embodiments can easily be implemented for use on most currently used and possible future styles of rim and tire designs. Specially designed grappling hooks would easily interchange via the removal and re-installation of the pivot pin.

In another embodiment the grappling hook improves the durability of the bead breaker by placing a larger landing surface for the drive bolt that actuates the hook. These larger landing angles further provide greater mechanical advantage to the grappling and clamping of the bead breaker to the rim. The larger landing angles on the grappling hook offer greater ease of turning by the drive bolt as a result of a hardened surface material at the point of contact and greater overall surface area.

In yet another embodiment, the improvement to the bead breaker includes a right angle leverage point that serves to increase the stability to the bead breaker during operation and greater setting force to the grappling hook during the clamping procedure. It also serves as a handling device that offers greater ease of use when the bead breaker is used on tires and wheels in the vertical position. This is accomplished via a cylindrical length of tubing fastened or welded at a right angle to the drive housing of the bead breaker.

These elements used in conjunction with a manually driven or air impact driven bead breaker serves to vastly improve the ease and range of use associated with a portable bead breaker unit.

Other objects, advantages, and novel features, and further scope of applicability of the presently claimed invention will be set forth in part in the detailed description to follow, taken in conjunction with the accompanying drawings, and in part will become apparent to those skilled in the art upon examination of the following, or may be learned by practice of the claimed invention. The objects and advantages of the claimed invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention, and together with the description serve to explain the principles of the invention. The drawings are only for the purpose of illustrating a preferred embodiment of the invention and are not to be construed as limiting the invention. In the drawings:

FIG. 1 is a perspective view of the preferred embodiment of the improved tire bead breaker.

FIG. 2 is a side view of the preferred embodiment of the improved tire bead breaker.

FIG. 3 is a perspective view of the preferred embodiment of the improved tire bead breaker grappling hook.

FIG. 4 is a side view of the preferred embodiment of the improved tire bead breaker grappling hook.

FIG. 5 is a side view of the preferred embodiment of the improved tire bead breaker and a side cross sectional view of a tire and rim in the first stage of setting the tool by clamping the breaker to the rim.

FIG. 6 is a side view of the preferred embodiment of the improved bead breaker and a side cross sectional view of a tire and rim in the second stage with the clamping forks fully set between the tire bead and rim.

FIG. 7 is a side view of the preferred embodiment of the improved bead breaker and a side cross sectional view of a tire and rim in the final stage with the stripping wedge driving the bead free of the rim.

FIG. 8 is a side view of the preferred embodiment of the improved bead breaker and a side cross sectional view of afire and rim illustrating the removal of the tool from service.

FIG. 9 is a side view of the preferred embodiment of the improved bead breaker and a side cross sectional view of a tire and rim illustrating a point of contact on the grapple hook.

FIG. 10 is a side view of the preferred embodiment of the improved bead breaker and a side cross sectional view of a tire and rim illustrating another point of contact on the grapple hook.

FIG. 11 is a side view of the preferred embodiment of the improved bead breaker and a side cross sectional view of a tire and rim illustrating yet another point of contact on the grapple hook.

### DESCRIPTION OF THE PREFERRED EMBODIMENTS

### Best Modes for Carrying Out the Invention

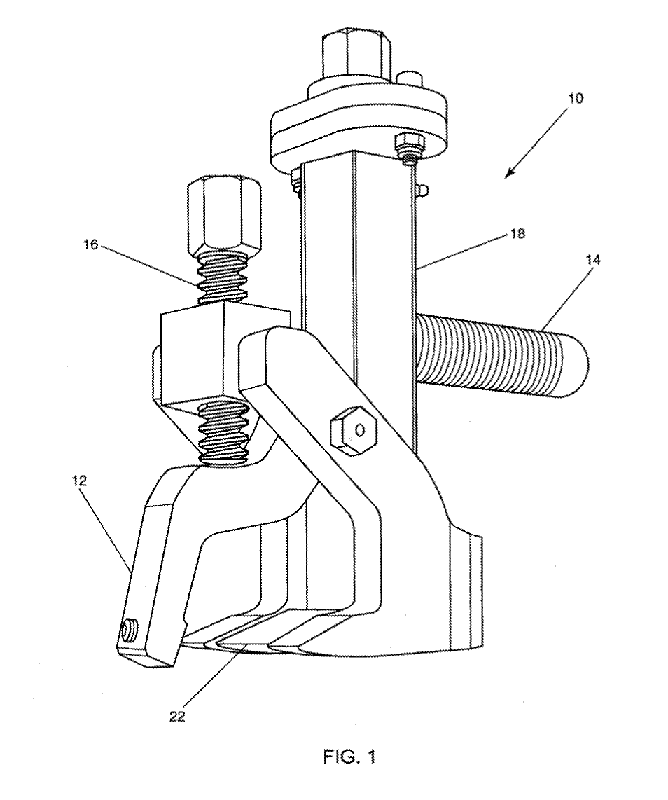

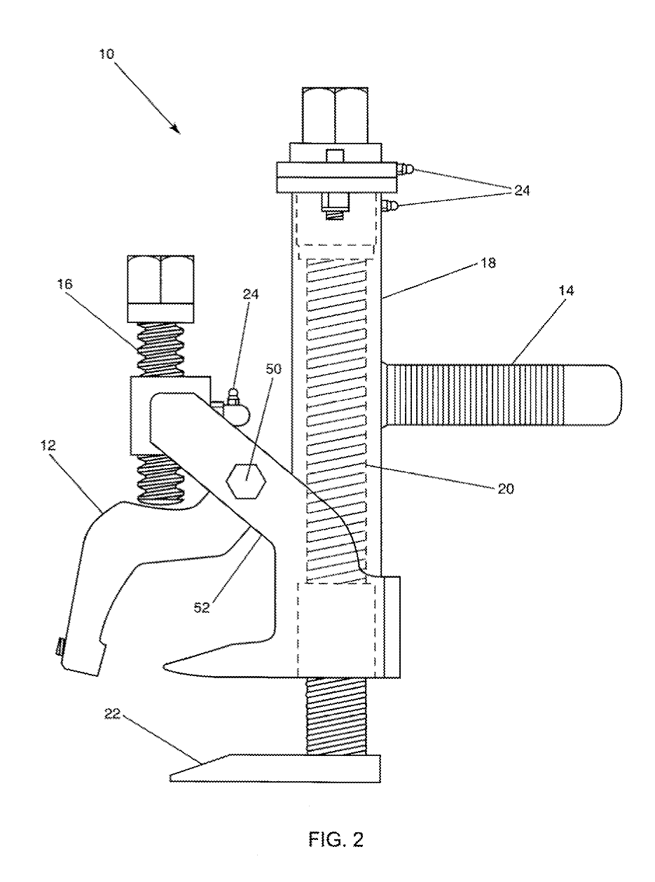

FIG. 1 is a perspective view of the preferred embodiment of the improved tire bead breaker 10. FIG. 2 is a side view of the preferred embodiment of the improved tire bead breaker 10 featuring the elements described herein. As shown in FIGS. 1 and 2, bead breaker 10 has a grappling hook 12 pivotally affixed by pin 50 to lower housing 52. Lower housing 52 is affixed to upper housing 18 as shown. Affixed to upper housing 18 is handle 14 which comprises a right angle leverage point. Heavy threaded first drive bolt 16 works in conjunction with grappling hook 12 to adjust the position of grappling hook. Upper housing 18 has internal heavy threaded second drive bolt 20 affixed to telescopically drive stripping wedge 22 of bead breaker. Grease points 24 can be included to increase the life of the first drive bolt 16 and second drive bolt 20.

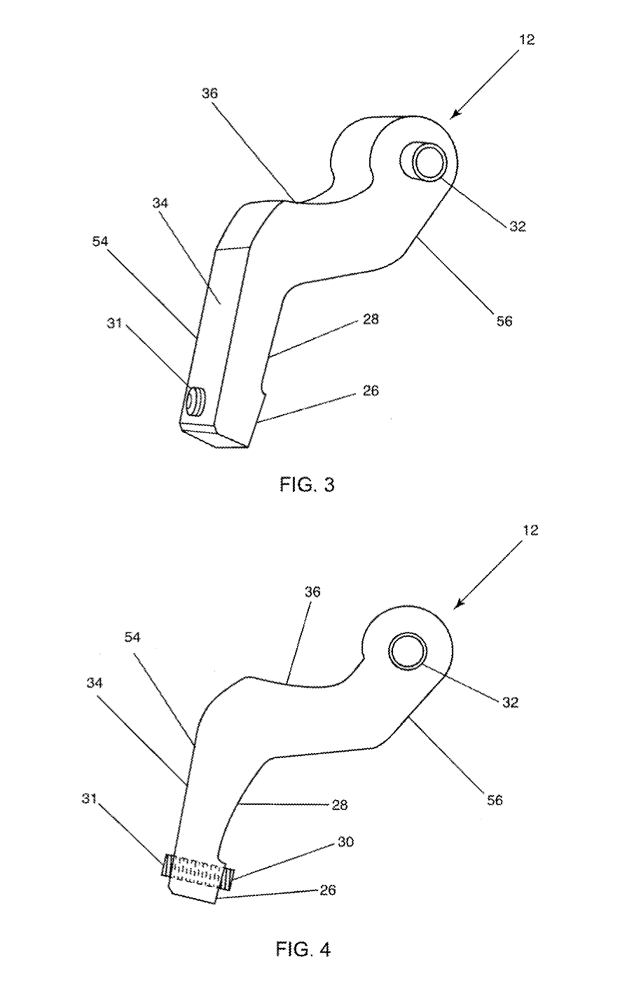

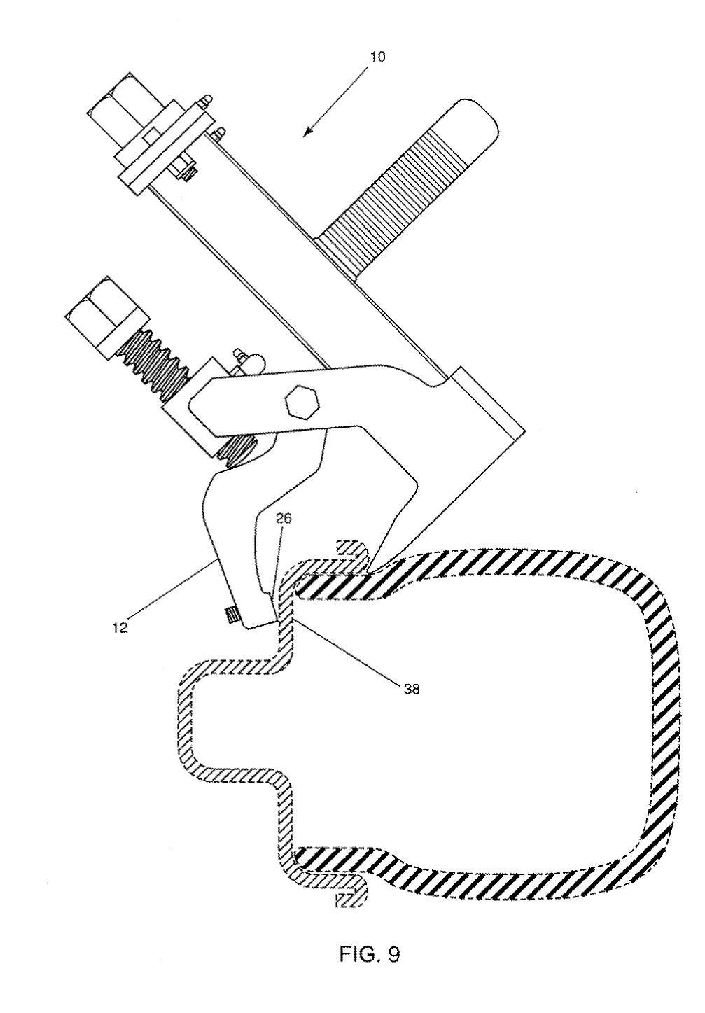

FIG. 3 is a perspective view of the preferred embodiment of tire bead breaker grappling hook 12 and FIG. 4 is a side view of FIG. 3. The design of grappling hook 12 provides for the versatility for use on a plurality of different types of rims with the provision of different points of contact. A first point of contact 26 on the multifunction grappling hook 12 is shown. The broad simple design of first point of contact 26 provides a less aggressive engagement of a rim. A second point of contact 28 on grappling hook 12 with a notch design provides for grappling of rims with ledges or flanges as illustrated in FIG. 9. Telescopic point of contact 30 illustrates the yet another point of contact on the multifunction grappling hook 12. A hardened set screw 31 is preferably the telescopic point of contact 30 and serves to offer a more aggressive engagement of the rim as is needed on commercial or agricultural tires by tightening hardened set screw 31. Bearing 32 provide for a fulcrum point or pivot for grappling hook 12 and secured by pin 50 of FIG. 2. Tapered shape 34 of lower portion 54 of grappling hook 12 allows for use of bead breaker 10 on confined spaced rims. Enlarged landing surfaces 36 of the upper portion 56 of grappling hook 12 provides greater mechanical force to grappling hook 12 as well as increased efficiency in the turning of first drive bolt 16. As shown, upper portion 56 is at an angle of approximately ninety degrees (90°) from lower portion 54.

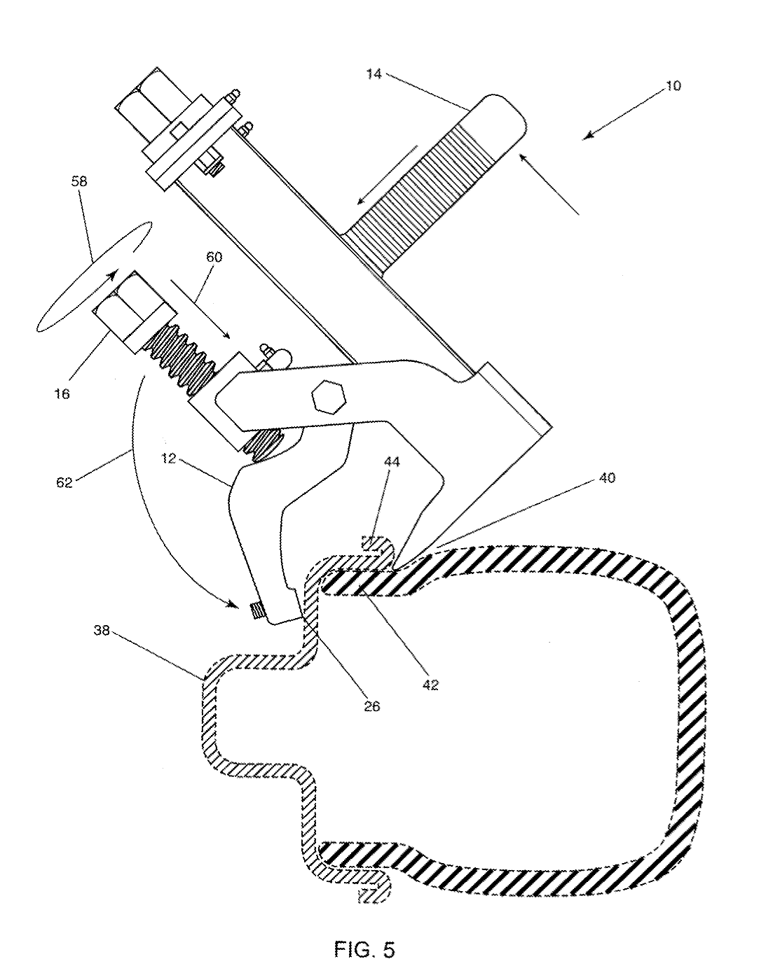

FIG. 5 is a side view of the preferred embodiment of tire bead breaker 10 and a side cross sectional view of a tire and rim in the first stage of setting the tool by clamping bead breaker 10 to rim 38 along with the following elements described herein. While providing downward and forward pressure on the right angle leverage point of handle 14, first drive bolt 16 is rotated in a counter clockwise motion 58, linearly driving 60 grappling hook 12 in a pivoting motion 62 and forcing wedge/clamping forks 40 between tire bead 42 and rim flange 44 by the motion and a stop provided by the first contact point 26 and rim 38. Right angle leverage point 14 provides additional gripping force to grappling hook 12 as first drive bolt 16 impinges on grappling hook 12 and forces wedge/clamping forks 40 increasingly between tire bead 42 and rim flange 44.

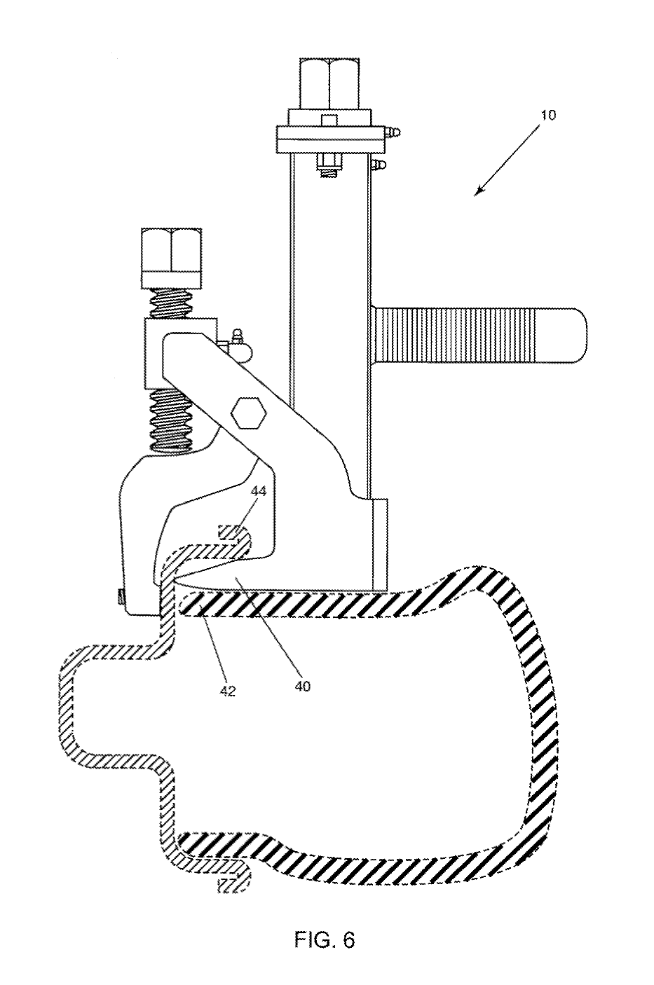

FIG. 6 is a side view of the preferred embodiment of bead breaker 10 and a side cross sectional view of a tire and rim in the second stage of breaking tire bead 42 with wedge/clamping forks 40 fully set between tire bead 42 and rim flange 44. After this stage is accomplished, the bead is now in the position to be fully broken in its final stage.

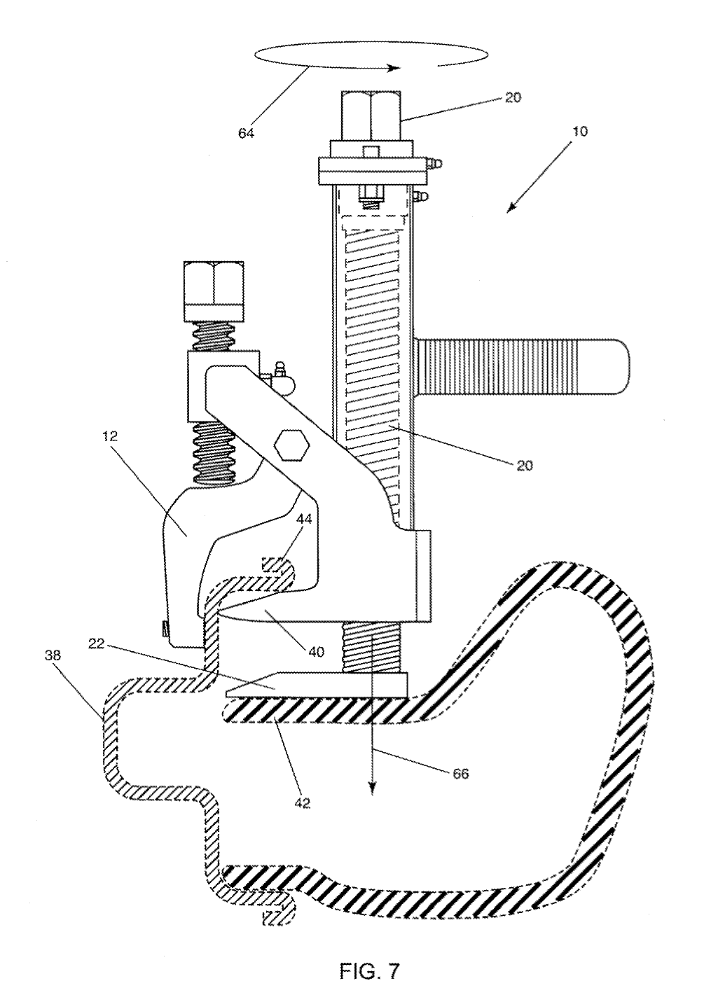

FIG. 7 is a side view of the preferred embodiment of bead breaker 10 and a side cross sectional view of a tire and rim in the final stage of breaking the bead. Stripping wedge 22 is engaged via counter clockwise rotation 64 of the secondary drive bolt 20. As stripping wedge 22 telescopically drives downward via rotation of secondary drive bolt 22, it fully removes or breaks tire bead 42 from rim flange 44 and the rim proper 38. During this operation wedge/clamping forks 40 and grappling hook 12 hold the entire assembly in place and provide a stable point from for the tire bead 42 pushing motion.

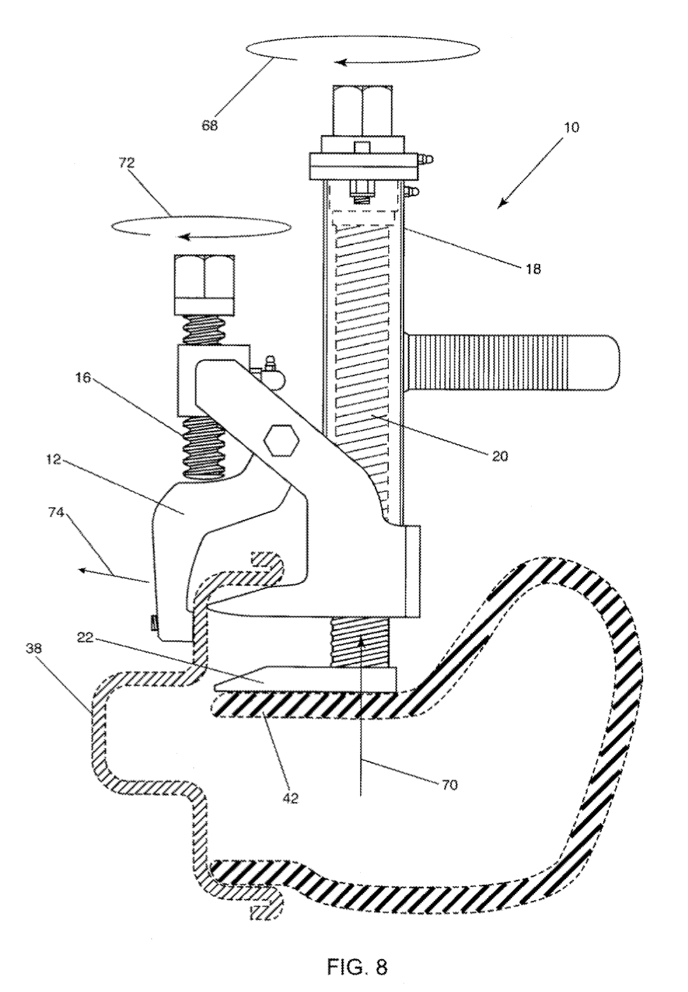

FIG. 8 is a side view of the preferred embodiment of bead breaker 10 and a side cross sectional view of a tire and rim illustrating the removal of the tool from service. By reversing secondary drive bolt 20 with a clockwise motion 68 it alleviates pressure on tire bead 42 and retracts 70 stripping wedge 22 telescopically into secondary drive bolt housing 18. Once fully retracted first drive bolt 16 can be reversed with a clockwise motion 72 effectively releasing grappling hook 12 from rim 38, grappling hook can be pivoted 74 away from rim 38 and thereby removing the tool from service.

FIG. 9 is a side view of another embodiment of bead breaker 10 and a side cross sectional view of a tire and rim illustrating first point of contact 26 on multifunction grappling hook 12 gripping the interior of an alloy or chrome rim 38. This point of contact 26 has a broadened or increased surface design to be less aggressive and to alleviate cosmetic damage to decorative rims. The operation of bead breaker 10 is similar to the FIGS. 5-8 and the description as set forth above.

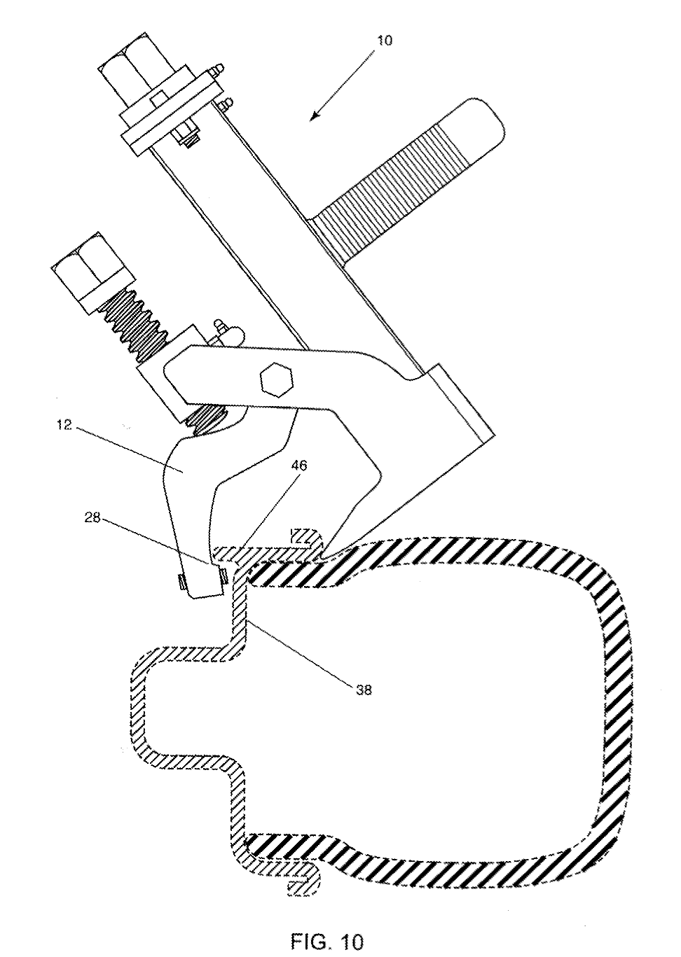

FIG. 10 is a side view of another preferred embodiment of bead breaker 10 and a side cross sectional view of a tire and rim illustrating a second point of contact 28 on multifunction grappling hook 12 gripping the interior of a rim 38 with a ledge or flange 46. Second point of contact 28 comprises a notch on grappling hook 12 that works well in applications where an overhanging point of contact is needed. The operation of bead breaker 10 is similar to the FIGS. 5-8 and the description as set forth above.

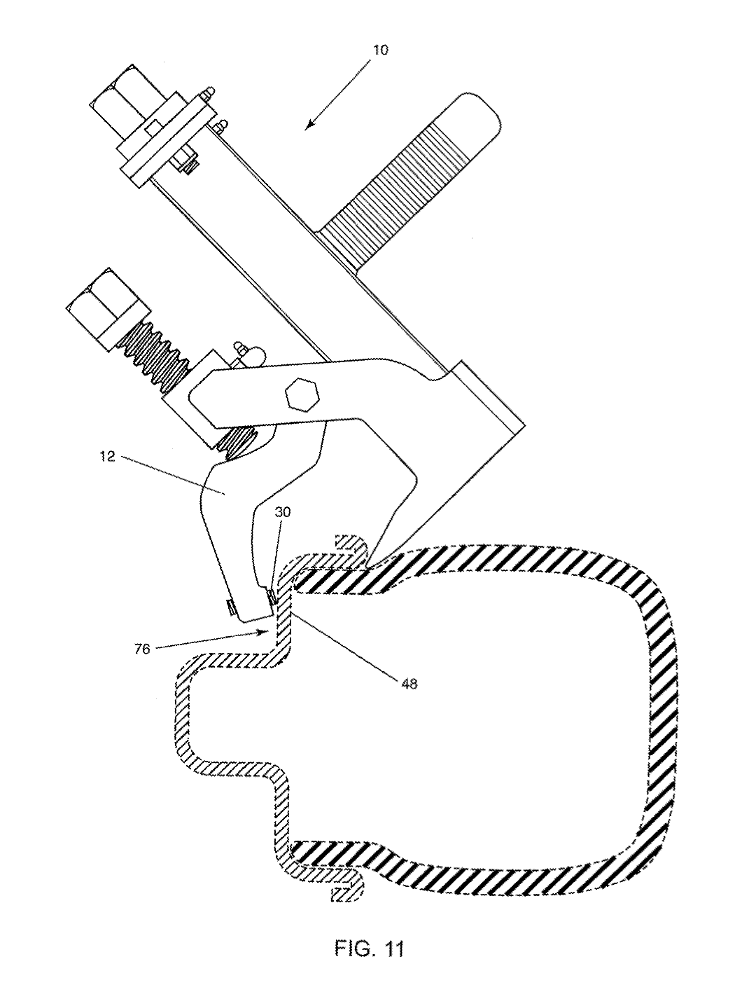

FIG. 11 is a side view of yet another preferred embodiment of bead breaker 10 and a side cross sectional view of a tire and rim illustrating a telescopic point of contact 30 on multifunction grappling hook 21 gripping the interior of a commercial or agricultural rim 48. This telescopic point of contact 30 works via a hardened set screw with an aggressive edge by “biting” or “gouging” the interior rim 48 by tightening hardened set screw and thereby ensuring an aggressive gripping point. This is especially desirable in commercial or agricultural applications where added gripping force is needed.

Although the claimed invention has been described in detail with particular reference to these preferred embodiments, other embodiments can achieve the same results. Variations and modifications of the presently claimed invention will be obvious to those skilled in the art and it is intended to cover in all such modifications and equivalents. The entire disclosures of all references, applications, patents, and publications cited above, are hereby incorporated by reference.

What is claimed is:

1. A tire bead breaker comprising:
a housing;
a handle affixed to said housing comprising a leveraging point;
a telescoping stripping wedge disposed in the housing for forcing the tire bead from the rim; and
a three contact point pivoting grappling hook for contacting the rim.
